(19) United States
(12) Patent Application Publication
(10) Pub. No.: US 2002/0027136 A1
(43) Pub. Date: Mar. 7, 2002

(54) Power supply apparatus of microwave oven

(76) Inventor: Min Ki Lee, Changwon (KR)

Correspondence Address: BIRCH STEWART KOLASCH & BIRCH, PO BOX 747, FALLS CHURCH, VA, 22040-0747, US

(21) Appl. No.: 09/921,873

(22) Filed: Aug. 6, 2001

(30) Foreign Application Priority Data
Sep. 1, 2000 (KR) 51674/2000

(51) Int. Cl. H05B 6/66

(52) U.S. Cl. 219/715; 219/702

(57) ABSTRACT

A power supply apparatus including: a power supply unit receiving a common AC power and generating a DC power; a constant voltage generator receiving the DC power and outputting a pre-set rated DC voltage; a controller receiving the rated DC voltage and outputting a control signal; and an outputting unit receiving the DC power to the rated DC voltage and being operated according to the control signal. As the single DC power converted from the common AC power is supplied to the peripheral circuit units of a microwave oven, the peripheral circuit units are controlled accordingly. And, since the single power is used, the power supply circuit is simple, contributing to lower down a product cost.

### BACKGROUND OF THE INVENTION

1. Field of the Invention

The present invention relates to a power supply apparatus of a microwave oven, and more particularly, to a power supply apparatus of a microwave oven in which a single DC power converted from a common AC power is supplied to peripheral circuits of a microwave oven and controls them.

2. Description of the Background Art

FIG. 1 is a schematic block diagram of a power supply apparatus of a microwave oven in accordance with a conventional art.

As shown in FIG. 1, a main power supply unit 11 receiving a common AC power and generating a first DC power, an auxiliary power supply unit 12 induced from the main power supply unit 11, for generating a second DC power, a constant-voltage generating unit 13 receiving the first DC power and outputting a pre-set rated DC voltage; a microcomputer 17 receiving the rated DC voltage and outputting a plurality of control signals; a relay unit 14 receiving the first DC power and controlling an operation of a circuit unit (not shown) according to a first control signal of the plurality of control signals; a buzzer unit 15 receiving the first DC power and outputting a sound of audible frequency according to a second control signal of the plurality of control signals; and a display unit 16 receiving the second DC power and outputting a visible ray according to a third control signal of the plurality of control signals.

The main power supply unit 11 includes a transformer TR1 transforming a voltage of the AC power; diodes D1 and D2 rectifying an AC power outputted from a first secondary coil part CL1 to a full-wave power; and a first capacitor C1 receiving the full-wave power, charging and discharging an electric charge and generating a first DC power, for example, 12V.

The auxiliary power supply unit 12 includes a diode D3 rectifying the AC power outputted from the secondary coil part CL2 of the transformer TR1 to a half-wave power, and a second capacitor C1′ receiving the half-wave power, charging and discharging an electric charge, and generating a second DC power, i.e., 5V.

The constant-voltage generating unit 13 includes a regulator 13-1 receiving the first DC power and generating a rated voltage, i.e., 5V, and a third capacitor C2 removing a noise of the rated voltage outputted from the regulator 13-1.

The relay unit 14 includes a relay L1 receiving the first DC power and operating according to the first control signal, a transistor Q1 receiving the first control signal and controlling the operation of the relay L1, and a diode D4 preventing a back electromotive force of the relay L1.

The buzzer unit 15 includes a buzzer 15-1 receiving the first DC power and outputting an audible frequency according to the second control signal, a transistor Q5 receiving the second control signal and controlling an operation of the buzzer 15-1, and resistors R1 and R2 generating an operating voltage and a current of the buzzer 24-1.

The display unit 16 includes a light emitting diode LED1 receiving the second DC power and outputting a visible ray according to the third control signal, a transistor Q3 controlling the operation of the light emitting diode LED1, and a voltage dropping resistor R3 generating an operating voltage of the light emitting diode LED1.

The operation of the power supply apparatus of a microwave oven constructed as describe above will now be described.

When an AC power is inputted, a DC power is supplied to each circuit unit. Then, when the user operates a microwave oven, the microwave oven is operated according to a program which has been previously programmed and stored in the microcomputer.

Accordingly, in order to externally output a corresponding operation situation of the microwave oven, the microcomputer outputs the first to the third signal, according to which the relay performs a switching operation upon receipt of the control signals, the buzzer outputs a sound, and the light emitting diode LED1 emits a visible ray.

However, the conventional power supply apparatus of a microwave oven has several problems.

That is, for example, since the power supply apparatus uses two DC power generated by using dual power supply method (two powers are outputted from the secondary coil part of the transformer), the power supply circuit is complicate and makes a product expensive.

That is, one of DC power outputted from a transformer adopting the dual power supply method is supplied to the relay, the buzzer and the regulator, and the other of the DC power is supplied to drive the light emitting diode.

### SUMMARY OF THE INVENTION

Therefore, an object of the present invention is to provide a power supply apparatus of a microwave oven with a simple circuit.

To achieve these and other advantages and in accordance with the purpose of the present invention, as embodied and broadly described herein, there is provided a power supply apparatus including: a power supply unit receiving a common AC power and generating a DC power; a constant voltage generator receiving the DC power and outputting a pre-set rated DC voltage; a controller receiving the rated DC voltage and outputting a control signal; and an outputting unit receiving the DC power to the rated DC voltage and being operated according to the control signal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram of a power supply apparatus of a microwave oven in accordance with a conventional art; and

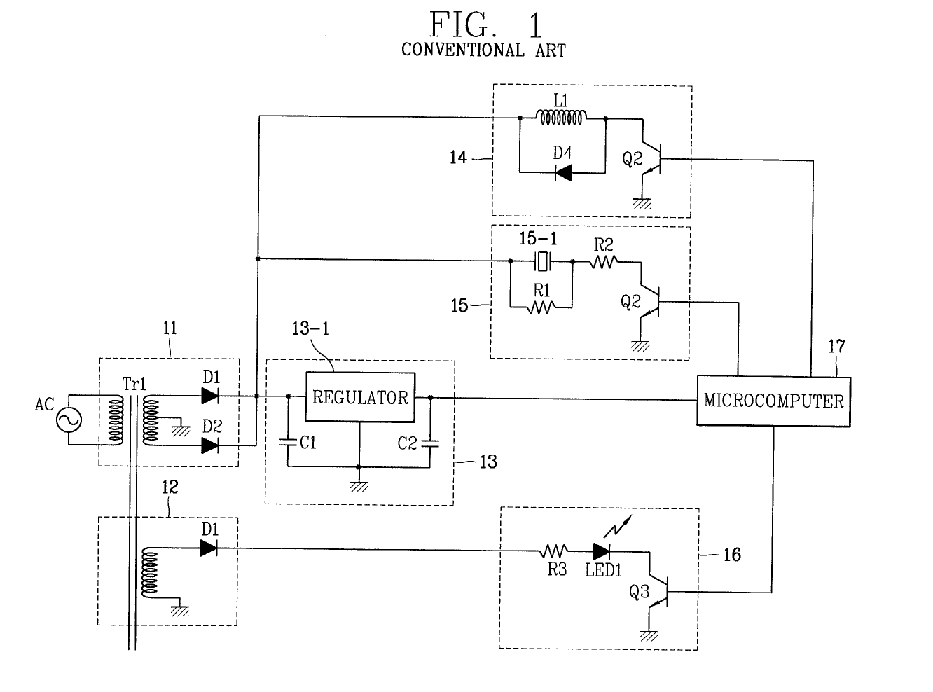

FIG. 2 is a schematic block diagram of a power supply apparatus of a microwave oven in accordance with a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

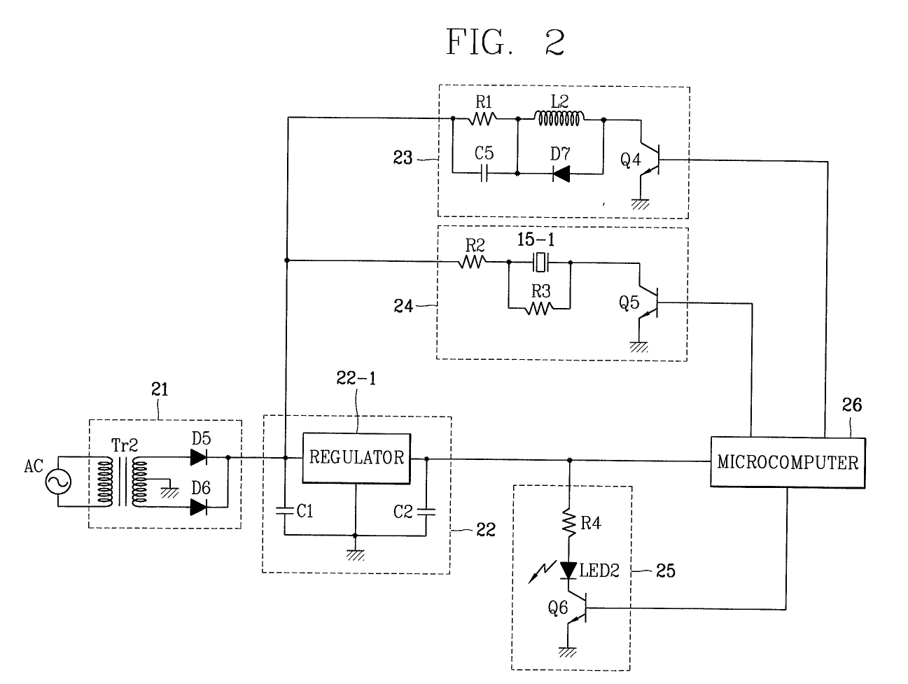

FIG. 2 is a schematic block diagram of a power supply apparatus of a microwave oven in accordance with a preferred embodiment of the present invention.

As shown in FIG. 2, a power supply apparatus of a microwave oven of the present invention includes a power supply unit 21 receiving a common AC power and generating a DC power, a constant-voltage generating unit 22 receiving the DC power and outputting a pre-set rated DC voltage, a microcomputer 26 receiving the rated DC voltage and outputting a plurality of control signals, a relay unit 23 receiving the DC power and controlling an operation of other circuit unit (not shown) according to a first control signal of the plurality of control signals, a buzzer unit 24 receiving the DC power and outputting a sound of an audible frequency according to a second control signal of the plurality of control signals, and a display unit 25 receiving the rated DC voltage and externally outputting a visible ray according to a third control signal of the plurality of control signals.

The power supply unit 21 includes a transformer TR2 transforming a voltage of the AC power, diodes D5 and D6 rectifying the AC power outputted from the transformer TR2 to a full-wave power, and a first capacitor C3 receiving the full-wave power, charging and discharging the electric charge and generating a DC power, i.e., 8V.

The constant-voltage generating unit 22 includes a regulator 22-1 receiving the DC power and generating a pre-set rated voltage, i.e., 5V, and a second capacitor C4 removing a noise of the rated voltage outputted from the regulator 22-1.

The relay unit 23 includes a relay (L2, for example, an operating voltage is 6V) receiving the DC power and operating according to the first control signal, a transistor Q4 receiving the first control signal and controlling the operation of the relay L2, a diode D7 preventing a back electromotive force of the relay L2, and a capacitor C5 connected in parallel to a voltage-dropping resistor R4.

The buzzer unit 24 includes a buzzer 24-1 receiving the DC power and outputting an audible frequency according to the second control signal, a transistor Q5 receiving the second control signal and controlling the operation of the buzzer 24-1, and resistors R5 and R6 generating an operating voltage and current of the buzzer 24-1.

The display unit 25 includes a light emitting diode LED2 receiving the rated DC voltage and outputting a visible ray according to the third control signal, a transistor Q6 controlling the operation of the light emitting diode LED2, and a voltage-dropping resistor R7 generating an operating voltage of the light emitting diode LED2. In the preferred embodiment of the present invention, the light emitting diode is installed by one, but more than 2 light emitting diodes may be connected.

The operation of the power supply apparatus of a microwave oven constructed as described above will now be explained.

When an AC power is inputted, a DC power is supplied to each circuit unit. And then, when a user operates a microwave oven, the microwave oven is operated according to a program previously stored in the microcomputer.

Accordingly, as the microcomputer outputs a first to a third control signals in order to externally output a corresponding operation situation of the microwave oven, the relay performs a switching operation upon receipt of the control signals, the buzzer outputs a sound, and the light emitting diode LED2 emits a visible ray.

The operation will now be describe in more detail. When a common AC power is inputted to the primary side of the transformer TR2, the full-wave power is outputted through the diodes D5 and D6 of the secondary side of the transformer TR2, and the full-wave power becomes a DC power (including small ripples), for example, 8V, by the capacitor C3.

The regulator 22-1 receives the 8V, converts it to a rated voltage, i.e., 5V, and outputs it. A noise of the outputted rated voltage is canceled by the capacitor C4 and the voltage without a noise is supplied to the microcomputer 26.

In addition, the rated voltage is also supplied to the display unit 25, dropped by the resistor R7 and then supplied to the light emitting diode LED2.

At this time, the light emitting diode LED2 is connected to the transistor Q6 and the transistor Q6 receives the control signal from the microcomputer 26. Accordingly, as the transistor performs a switching operation according to the control signal, the operation of the light emitting diode LED2 is controlled.

The DC power is also supplied to the relay unit 23 and the buzzer unit 24.

The DC power inputted to the relay unit 23 is voltage-dropped by the resistor R4 and supplied to the relay as an operating power to operate the relay L2.

At this time, the capacitor C5 stabilizes the power inputted at the initial stage that the power is supplied, and maintains the rated voltage for enabling the relay to be operated during the operation of the relay.

The relay is connected to the transistor Q4, and the transistor Q4 receives the control signal from the microcomputer 26, and the transistor Q4 performs a switching operation according to the control signal, whereby the operation of the relay is controlled.

Likewise, the DC power inputted to the buzzer unit 24 is voltage-dropped by the resistor R5, and supplied as an operating power to the buzzer 24-1.

At this time, the resistor R6 renders a certain voltage to be formed at the buzzer. The buzzer is connected to the transistor Q5, and the control signal is received from the microcomputer 26 to the transistor Q6. As the transistor Q5 performs a switching operation according to the control signal, the operation of the buzzer is controlled.

As so far described, the power supply apparatus of a microwave oven of the present invention has the following advantage. That is, for example, as the single DC power converted from the common AC power is supplied to the peripheral circuit units of a microwave oven, the peripheral circuit units are controlled accordingly. And, since the single power is used, the power supply circuit is simple, contributing to lower down a product cost.

In the preferred embodiment of the present invention, though the transistor is used to control the buzzer, the relay and the light emitting diode, any device having a switching function may be used instead.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A power supply apparatus comprising:
a power supply unit receiving a common AC power and generating a DC power;
a constant voltage generator receiving the DC power and outputting a preset rated DC voltage;
a controller receiving the rated DC voltage and outputting a control signal; and
an output unit receiving the DC power to the rated DC voltage and being operated according to the control signal.

2. The apparatus of claim 1, wherein the power supply unit comprises:
a transformer transforming a voltage of the AC power;
diodes rectifying the AC power outputted from the transformer to a full-wave power; and
a first capacitor receiving the full-wave power, charging and discharging the electric charge and generating a DC power.

3. The apparatus of claim 1, wherein the constant-voltage generating unit comprises:
a regulator receiving the DC power and generating a pre-set rated voltage; and
a second capacitor removing a noise of the rated voltage outputted from the regulator.

4. The apparatus of claim 1, wherein the controller generates a plurality of control signals.

5. The apparatus of claim 4, wherein the output unit comprises:
a first output part receiving the DC power and operating according to the first control signal; and
a second output part receiving the rated DC voltage and operating according to the second control signal.

6. The apparatus of claim 5, wherein the first output part is a switch for operating an external unit.

7. The apparatus of claim 6, wherein the switch is a relay.

8. The apparatus of claim 5, wherein the first output part is a vibrator vibrating with a predetermined frequency according to the control signal.

9. The apparatus of claim 8, wherein the vibrator outputs an audible frequency.

10. The apparatus of claim 5, wherein the second output part is a display unit.

11. The apparatus of claim 10, wherein the display unit is a light emitting diode for outputting a visible ray.

12. The apparatus of claim 1, wherein the output unit includes a switch operating according to the control signal.

13. The apparatus of claim 12, wherein the switch is a transistor.
